(19) United States
(12) Patent Application Publication
(10) Pub. No.: US 2025/0220263 A1
(43) Pub. Date: Jul. 3, 2025

(54) LIVE-STREAMING ROOM DISPLAY METHOD AND APPARATUS, ELECTRONIC DEVICE, STORAGE MEDIUM, AND PROGRAM PRODUCT

(71) Applicant: Beijing Zitiao Network Technology Co., Ltd., Beijing (CN)

(72) Inventors: Yijie LI, Beijing (CN); Hui XUAN, Beijing (CN)

(21) Appl. No.: 18/853,087

(22) PCT Filed: Mar. 15, 2023
(86) PCT No.: PCT/CN2023/081591

§ 371 Date: Sep. 30, 2024

(30) Foreign Application Priority Data
Mar. 31, 2022 (CN) 202210346862.4

(51) Int. Cl. H04N 21/431; H04N 21/2187; H04N 21/472

(52) U.S. Cl. CPC H04N 21/4312; H04N 21/2187; H04N 21/472

(57) ABSTRACT

The present disclosure relates to a live-streaming room display method and apparatus, an electronic device, a storage medium, and a program product. The method comprises: displaying an aggregated live-streaming room card in a live-streaming preview page, the aggregated live-streaming room card being a live-streaming room card corresponding to a plurality of live-streaming rooms; and in response to a first trigger operation on the aggregated live-streaming room card, displaying a live-streaming room page of a target live-streaming room among the plurality of live-streaming rooms.

### CROSS-REFERENCE TO RELATED APPLICATIONS

The present disclosure is based on and claims priority to Chinese Application No. 202210346862.4 filed on Mar. 31, 2022, the disclosure of which is incorporated by reference herein in its entirety.

### TECHNICAL FIELD

The present disclosure relates to the field of live technologies, and in particular to a live room display method and apparatus, an electronic device, a storage medium, and a program product.

### BACKGROUND

Under the wave of the Internet, the continuous development and evolution of hardware and software technologies have promoted the emergence of intelligent devices and software. Meanwhile, the live service technologies become mature continuously and can be embedded into different application platforms, and users can view programs such as news, sports events, shopping recommendations and the like online through the network live.

### SUMMARY

The present disclosure provides a live room display method and apparatus, an electronic device, a storage medium, and a program product.

According to a first aspect of an embodiment of the present disclosure, there is provided a live room display method, which comprises: displaying in a live preview page an aggregation live room card which is a live room card corresponding to a plurality of live rooms; displaying, in response to a first trigger operation on the aggregation live room card, a live room page of a target live room among the plurality of live rooms.

Optionally, the aggregation live room card includes a first region; the displaying in a live preview page an aggregation live room card comprises: alternately displaying in the first region live room information of each of the plurality of live rooms, or alternately/fixedly displaying in the first region live room information of a live room meeting a first condition among the plurality of live rooms.

Optionally, the first trigger operation is used for triggering entering a target live room of the first region; the displaying a live room page of a target live room among the plurality of live rooms comprises: displaying a live page of the target live room when the target live room is currently in a live state; displaying a forecast page or a recording page of the target live room when the target live room is currently not in a live state.

Optionally, the aggregation live room card further comprises a second region, and the first region is larger than the second region; the displaying in a live preview page an aggregation live room card comprises: alternately displaying in the second region live room information of at least two of the plurality of live rooms, or alternately/fixedly displaying in the second region live room information of a live room meeting a second condition among the plurality of live rooms.

Optionally, the target live room is a live room in a live state that is currently displayed in the second region; the displaying a live room page of a target live room among the plurality of live rooms comprises: displaying a live page of a live room currently displayed in the second region.

Optionally, the method further comprises: updating at least one live room currently displayed in the second region, when updating in the first region live rooms currently in an alternate displaying state.

Optionally, a first fully displayed live room in the second region is a live room currently displayed in the first region, or the second region does not include a live room currently displayed in the first region.

Optionally, the method further comprises: cancelling, in response to a trigger operation for the second region, displaying of the second region, and adaptively adjusting a display size of the first region.

Optionally, the aggregation live room card comprises a plurality of sub cards, each of which displays a preview cover or a live preview stream of a live room; the displaying, in response to a first trigger operation on the aggregation live room card, a live room page of a target live room among the plurality of live rooms comprises: entering, in response to a trigger operation for any one of the plurality of sub cards, a live room page corresponding to the any one sub card.

Optionally, the method further comprises: maintaining, in response to a swipe trigger operation for a live preview page, displaying of the aggregation live room card in a preset region of the live preview page.

Optionally, each of the plurality of live rooms meets at least one of the following: a live room with a recommendation index larger than a preset threshold; a followed live room; a preset one of the plurality of live rooms.

According to a second aspect of an embodiment of the present disclosure, there is provided a live room display apparatus, which comprises: a display module for displaying in a live preview page an aggregation live room card which is a live room card corresponding to a plurality of live rooms; displaying, in response to a first trigger operation on the aggregation live room card, a live room page of a target live room among the plurality of live rooms.

Optionally, the aggregation live room card comprises a first region; the display module is specifically used for alternately displaying in the first region live room information of each of the plurality of live rooms, or alternately/fixedly displaying in the first region live room information of a live room meeting a first condition among the plurality of live rooms.

Optionally, the first trigger operation is used for triggering entering a target live room of the first region; the display module is specifically used for displaying a live page of the target live room when the target live room is currently in a live state; displaying a forecast page or a recording page of the target live room when the target live room is currently not in a live state.

Optionally, the aggregation live room card further comprises a second region, and the first region is larger than the second region; the display module is specifically used for alternately displaying in the second region live room information of at least two of the plurality of live rooms, or alternately/fixedly displaying in the second region live room information of a live room meeting a second condition among the plurality of live rooms.

Optionally, the target live room is a live room in a live state that is currently displayed in the second region; the display module is specifically used for displaying a live page of a live room currently displayed in the second region.

Optionally, the apparatus further comprises: an update module, which is used for updating at least one live room currently displayed in the second region, when updating in the first region the live room currently in an alternate displaying state.

Optionally, a first fully displayed live room in the second region is a live room currently displayed in the first region; or the second region does not include a live room currently displayed in the first region.

Optionally, the display module is further used for cancelling, in response to a trigger operation for the second region, displaying of the second region, and adaptively adjusting a display size of the first region.

Optionally, the aggregation live room card comprises a plurality of sub cards, each of which displays a preview cover or a live preview stream of the live room; the display module is specifically used for entering, in response to a trigger operation for any one of the plurality of sub cards, a live room page corresponding to the any one sub card.

Optionally, the display module is further used for maintaining, in response to a swipe trigger operation for a live preview page, displaying of the aggregation live room card in a preset region of the live preview page.

Optionally, each of the plurality of live rooms meets at least one of the following: a live room with a recommendation index larger than a preset threshold; a followed live room; a preset one of the plurality of live rooms.

According to a third aspect of an embodiment of the present disclosure, there is provided an electronic device, which comprises a processor, a memory, and a computer program stored in the memory and operated on the processor, which, when executed by the processor, implements the live room display method according to the first aspect.

According to a fourth aspect of an embodiment of the present disclosure, there is provided a computer readable storage medium storing thereon a computer program which, when executed by a processor, implements the live room display method according to the first aspect.

According to a fifth aspect of an embodiment of the present disclosure, there is provided a computer program product, wherein, the computer program product includes a computer program which, when operated on a processor, causes the processor to execute the computer program to implement the live room display method according to the first aspect.

According to a sixth aspect of an embodiment of the present disclosure, there is provided a chip, which includes a processor and a communication interface, wherein the communication interface is coupled to the processor, and the processor is used for operating program instructions to implement the live room display method according to the first aspect.

### BRIEF DESCRIPTION OF THE DRAWINGS

The accompanying drawings, which are therein incorporated into and constitute a part of the present specification, illustrate embodiments consistent with the present disclosure and, together with the specification, serve to explain the principles of the present disclosure.

In order to more clearly illustrate the embodiments of the present disclosure or the technical solutions in the related art, the drawings to be used in the description of the embodiments or the related art will be briefly introduced below. It is obvious for those skilled in the art to obtain other drawings according to these drawings without inventive effort.

FIG. 1 is a schematic flow diagram of a live room display method provided by an embodiment of the present disclosure;

FIG. 2 is a first schematic diagram of an aggregation live room card of a live room display method provided by an embodiment of the present disclosure;

FIG. 3 is a second schematic diagram of an aggregation live room card of a live room display method provided by an embodiment of the present disclosure;

FIG. 4 is a schematic diagram of an interface of a live room display method provided by an embodiment of the present disclosure;

FIG. 5 is a structural block diagram of a live room display apparatus provided by an embodiment of the present disclosure;

FIG. 6 is a structural block diagram of an electronic device provided by an embodiment of the present disclosure.

### DETAILED DESCRIPTION

In order to more clearly understand the above-described features and advantages of the present disclosure, the solutions of the present disclosure will be further described below. It should be noted that, in the case of no conflict, the embodiments and features in the embodiments of the present disclosure may be combined with each other.

In the following description, numerous specific details are set forth in order to provide a thorough understanding of the present disclosure, but the present disclosure may be implemented otherwise than as described herein. It is obvious that the embodiments in the specification are only a part of the embodiments of the present disclosure, and not all embodiments.

The terms “first”, “second” and the like in the specification and in the claims of the present disclosure are used for distinguishing between similar elements and not for describing a particular sequential or chronological order. It should be understood that the data so used can be interchanged under appropriate circumstances such that embodiments of the present disclosure can be implemented in an order other than those illustrated or described herein, and that objects distinguished by the “first”, “second” and the like are generally of one class, and the number of objects is not limited, for example, a first object can be one or more objects. In addition, “and/or” in the specification and claims represents at least one of the connected objects, and a character “/” generally represents that the former and latter associated objects are in an “or” relationship.

The electronic device in an embodiment of the present disclosure can be a mobile electronic device or a non-mobile electronic device. The mobile electronic device can be a mobile phone, a tablet computer, a notebook computer, a palm top computer, a vehicle-mounted electronic device, a wearable device, an ultra-mobile personal computer (UMPC), a netbook or a Personal Digital Assistant (PDA), etc.; the non-mobile electronic device can be a Personal Computer (PC), a Television (TV), a teller machine or a self-service machine, etc.; the embodiment of the present disclosure is not particularly limited.

An execution subject of the live room display method provided by an embodiment of the present disclosure can be the above-described electronic device (including a mobile electronic device and a non-mobile electronic device), or a functional module and/or a functional entity capable of implementing the live room display method in the electronic device, which may be specifically determined according to actual use requirements, and is not limited in an embodiment of the present disclosure.

Currently, a plurality of live room cards are included in a live preview page, and each live room card is used for indicating a live room in a live state. Therefore, the display form of the existing live room cards of the live preview page is too simple, so that in the case where there are many live rooms currently in a live state, the live preview page will include a large number of live room cards, which will make it difficult for users to find a live room conforming to requirements of users to view and degrade the user experience.

By combining the accompanying drawings, the live room display method provided by the embodiment of the present disclosure is described in detail below by specific embodiments and application scenarios thereof.

As shown in FIG. 1, an embodiment of the present disclosure provides a live room display method, which can include the following steps 101 to 102.

101, displaying in a live preview page an aggregation live room card.

The aggregation live room card is a live room card corresponding to a plurality of live rooms, which is an information aggregation card corresponding to the plurality of live rooms, which facilitates promotion of the information preview efficiency as compared with the existing live room card of a single live room.

It is to be understood that the plurality of live rooms include the target live room, and the target live room is any one of the plurality of live rooms or one live room meeting a certain condition (for example, a push condition, which can be specifically determined according to an actual situation, and is not limited here) among the plurality of live rooms.

Live room information of the plurality of live rooms includes: a live video preview stream, a live preview cover, a live streamer profile picture, a live room identification, or the like of each of a plurality of live rooms, wherein the live room information corresponding to each live room can be of the same type or of different types, which can be specifically determined according to an actual situation and is not limited here.

Illustratively, the live room information of each of the plurality of live rooms can be a live video preview stream of the corresponding live room; or the live room information of each of the plurality of live rooms can be a live preview cover of the corresponding live room; or the live room information of a part of the plurality of live rooms can be a live video preview stream of the corresponding live rooms, and the live room information of the other part of the plurality of live rooms is a live preview cover of the corresponding live room, which can be specifically determined according to an actual situation and is not limited here.

102, displaying, in response to a first trigger operation on the aggregation live room card, a live room page of a target live room among the plurality of live rooms.

Optionally, the first trigger operation can include a click input in a region of the aggregation live room card where live room information of the target live room is displayed, a swipe input in a region of the aggregation live room card where live room information of the target live room is displayed, and other feasible input in a region of the aggregation live room card where live room information of the target live room is displayed, which can be specifically determined according to an actual situation and is not limited in the embodiment of the present disclosure.

Optionally, the first trigger operation can include a click input on a target control in the aggregation live room card, a swipe input on a target control in the aggregation live room card, and other feasible input on a target control in the aggregation live room card, which can be specifically determined according to an actual situation and is not limited in the embodiment of the present disclosure. The target control is used for indicating entering a live room page of the target live room.

Optionally, the first trigger operation can further include a click input, a swipe input, or other input in any region of the aggregation live room card, which can be specifically determined according to an actual situation and is not limited in the embodiment of the present disclosure.

It is to be understood that the first trigger operation can be a single touch input or a gesture input, or can be a combined input including multiple touch inputs or gesture inputs, which can be specifically determined according to an actual situation.

Illustratively, the above-described click input can be a single click input, a double click input, or any number of click inputs, or can be a short-press input, a long-press input, or the like; the above-described swipe input can be a swipe input in any direction, such as an upward swipe input, a downward swipe input, a leftward swipe input, a rightward swipe input, a clockwise swipe input, or a counterclockwise swipe input, or the like. The above-described swipe input can also be a double-finger swipe input, a three-finger swipe input, or the like.

The live room page can also be referred to as a live room interface. The live room page can be a live page, a recording page, a forecast page or the like of a live room, which can be specifically determined according to an actual situation and is not limited in the embodiment of the present disclosure.

In the embodiment of the present disclosure, by receiving a first trigger operation on an aggregation live room card (aggregated with live room information of a plurality of live rooms) in a live preview page, a live room page of a target live room among the plurality of live rooms is displayed in response to the first trigger operation. In other words, the present solution not only can present live room information of the plurality of live rooms at the same time through the aggregation live room card, which improves the amount of live room information and improves the preview efficiency of live room information, but also can trigger entering a live room page of the target live room among the plurality of live rooms through the first trigger operation on the aggregation live room card, which is convenient for operation and can improve the user experience.

Optionally, the live preview page can include only the aggregation live room card; the live preview page can also include a plurality of live preview cards, each of which can be the aggregation live room card, or a part of which can be the aggregation live room cards and the other part of which can be the live room preview cards (used for indicating one live room, namely a single live room preview card). The plurality of live preview cards include the aggregation live room card in above-described step 101.

In the embodiment of the present disclosure, the live room preview card can be a live room preview cover, a live room video preview stream, or a live room streamer profile picture, and the like. The live room preview card can display a live room name (namely a live room streamer nickname), as well as related document information (also referred to as operation information) of the live room, wherein the related document information can refer to the following related description of the related document information of the live room currently in an alternate displaying state, and is not repeated here.

Optionally, the live preview page further includes a plurality of live room preview cards, each of which is used for indicating a live room. The aggregation live room card is presented at a first position of the live preview page, or presented among the plurality of live room preview cards arranged according to a preset arrangement rule, for example, presented between the S-th live room preview card and the S+1-th live room preview card, where S is a natural number.

The preset arrangement rule can be at least one of the following: presentation is made in a sequence from high to low of the live room recommendation indexes, where the recommendation indexes can be determined by using a known recommendation model, which is not repeated in detail. Certainly, the preset arrangement rule can be other arrangement rules, which are not limited here.

Optionally, the live room display method provided by the embodiment of the present disclosure can further include the following step 103.

103, maintaining, in response to a swipe trigger operation for a live preview page, displaying of the aggregation live room card in a preset region of the live preview page.

It is to be understood that the aggregation live room card can be presented in a preset region of a live room card presentation region (referred to as a presentation region) in the live preview page. In other words, the aggregation live room card is fixedly displayed in the presentation region. In a process of triggering update of the presented live room preview card in the live preview page through a swipe trigger operation, the aggregation live room card is always presented in the preset area of the presentation region, that is, the aggregation live room card is always visible to users. In this way, the exposure of a plurality of live rooms aggregated in the aggregation live room card can be better improved, and the user experience can be improved.

Optionally, each of the plurality of live rooms aggregated in the aggregation live room card meets at least one of the following: a live room with a recommendation index larger than a preset threshold; a followed live room; one of the plurality of live rooms preset by a user. The recommendation index can be determined by using a known recommendation model, which is not described in detail herein. The followed live room can be a live room followed by a user.

In the embodiment of the present disclosure, by setting the condition met by each of the plurality of live rooms, a live room can be recommended to users better through the aggregation live room card, which is convenient for users to obtain the live room meeting the requirements to view.

Optionally, the aggregation live room card includes a first region; the above-described step 101 can specifically include any one of the following steps 101a to 101c.

101a, alternately displaying in the first region live room information of each of the plurality of live rooms.

The so-called “alternately displaying” is to cyclically play live room information of each of a plurality of live rooms at a certain time interval (e.g., 10 minutes). If the live room information is a live video preview stream, then the live video preview stream of each live room is obtained in real time.

It is to be understood that a plurality of live rooms aggregated in the aggregation live room card are alternately displayed in the first region.

101b, alternately displaying in the first region live room information of live rooms meeting a first condition among the plurality of live rooms.

It is to be understood that live rooms meeting the first condition among the plurality of live rooms aggregated in the aggregation live room card are alternately displayed in the first region.

101c, fixedly displaying in the first region live room information of live rooms meeting a first condition among the plurality of live rooms.

Live rooms meeting a first condition among the plurality of live rooms aggregated in the aggregation live room card are fixed in the first region to be displayed.

The first condition can be determined according to an actual situation, and is not limited herein. For example, the first condition includes any one of the following: a live room with a recommendation index larger than or equal to an index threshold; a live room set by the user.

In the embodiment of the present disclosure, live room information is alternately or fixedly displayed in the first region. In this way, live room information of a plurality of live rooms not only can be presented at the same time but also can be alternately or fixedly displayed. The exposure of the live rooms can be better improved, and meanwhile users can determine whether the live rooms are of interest more quickly in first region.

Optionally, the aggregation live room card further includes a second region, and the first region is larger than the second region. The above-described step 101 can specifically include any one of the following steps 101d to 101f.

101d, alternately displaying in the second region live room information of at least two of the plurality of live rooms.

It is to be understood that at least any two of the plurality of live rooms aggregated in the aggregation live room card are alternately displayed in the second region.

101e, alternately displaying in the second region live room information of live rooms meeting a second condition among the plurality of live rooms.

It is to be understood that live rooms meeting a second condition among the plurality of live rooms aggregated in the aggregation live room card are alternately displayed in the second region.

101f, fixedly displaying in the second region live room information of live rooms meeting a second condition among the plurality of live rooms.

It is to be understood that live rooms meeting a second condition among the plurality of live rooms aggregated in the aggregation live room card are fixedly displayed in the second region.

The second condition can be determined according to an actual situation, and is not limited herein. For example, the second condition includes any one of the following: a live room with a recommendation index within a preset index range; a live room set by the user.

In the embodiment of the present disclosure, live room information is alternately or fixedly displayed in the first region, and live room information is alternately or fixedly displayed in the second region. In this way, live room information of a plurality of live rooms not only can be presented at the same time but also can be alternately or fixedly displayed. Furthermore, since the first region is larger than the second region, that is, live room information of some live rooms can be displayed in an enlarged area. The exposure of some live rooms can be better improved, and meanwhile users can determine whether the live rooms are of interest more quickly in first region.

In the embodiment of the present disclosure, the first trigger operation can be used for triggering entering any one live room presented in the aggregation live room card.

Optionally, the target live room is a live room in a live state that is currently displayed in the first region. The above-described step 102 can be specifically implemented by the following step 102a.

102a, displaying a live page of a live room currently displayed in the first region.

Optionally, a live video preview stream or a live preview cover of the target live room is currently displayed in the first region (i.e. live room information of the target live room), so that it is convenient for users to determine a current live content according to the live video preview stream or the live preview cover of the target live room before the first trigger operation is executed.

Optionally, the first trigger operation is used for triggering entering a live room displayed in the first region. Since the first region is large and only one live room is displayed in the first region, the first trigger operation can be an operation at any position in the first region, or an operation on a control (the above-described target control) indicating entering a live room displayed in the first region. In this way, the first trigger operation is used for triggering entering a live room displayed in the first region, which is convenient for operation and can improve the operation success rate and the operation efficiency. Moreover, users have viewed the live video preview stream or the live preview cover of the live room displayed in the first region, and thus can better determine that the live room is a live room meeting the requirement, and the probability that the live room is found to not meet the requirement and is then exited after the live room is entered can be reduced.

Optionally, the first trigger operation is used for triggering entering a target live room in the first region; the above-described step 102 can be specifically implemented by the following step 102b or step 102c.

102b, displaying a live page of the target live room when the target live room is currently in a live state.

102c, displaying a forecast page or a recording page of the target live room when the target live room is currently not in a live state.

It is to be understood that, the live room displayed in the first region can be a live room currently in a live state or a live room currently not in a live state. In this way, a live page, a recording page or a forecast page of the target live room can be quickly checked through the first trigger operation, and the diversity of displaying the live room page of the target live room in response to the first trigger operation can be improved.

Optionally, the target live room is a live room in a live state that is currently displayed in the second region. The above-described step 102 can be specifically implemented by the following step 102d.

102d, displaying a live page of a live room currently displayed in the second region.

Optionally, a live video preview stream or a live preview cover of the target live room (i.e. live room information of the target live room) is currently displayed in the second region, so that it is convenient for users to determine a current live content according to the live video preview stream or the live preview cover of the target live room before the first trigger operation is executed.

Optionally, the first trigger operation is used for triggering entering a live room displayed in the second region. Therefore, the first trigger operation can be an operation on a live room in a live state in the second region, or an operation on a control indicating entering a live room in a live state that is displayed in the second region. In this way, the first trigger operation is used for triggering entering a live room displayed in the second region, which is convenient for operation and can improve the operation success rate and the operation efficiency. Moreover, users have viewed the live video preview stream or the live preview cover of the live room displayed in the second region, and thus can better determine that the live room is a live room meeting the requirement, and the probability that the live room is found to not meet the requirement and is then exited after the live room is entered can be reduced.

Optionally, the first trigger operation is used for triggering entering a target live room in the second region. The above-described step 102 can be specifically implemented by the following step 102e or step 102f.

102e, displaying a live page of the target live room when the target live room is currently in a live state.

102f, displaying a forecast page or a recording page of the target live room when the target live room is currently not in a live state.

It is to be understood that, the live room displayed in the second region can be a live room currently in a live state or a live room currently not in a live state. In this way, a live page, a recording page or a forecast page of the target live room can be quickly checked through the first trigger operation, and the diversity of displaying the live room page of the target live room in response to the first trigger operation can be improved.

Optionally, the aggregation live room card includes a plurality of sub cards, each of which displays a preview cover or a live preview stream of the live room; the above-described step 102 can be specifically implemented by the following step 102g.

102g, entering, in response to a trigger operation for any one of the plurality of sub cards, a live room page corresponding to the any one sub card.

In the embodiment of the application, the aggregation live room card is composed of a plurality of sub cards, each of which indicates a live room. Through a trigger operation on any one sub card, entering a live room page corresponding to the sub card can be triggered. In this way, the operation mode of entering a live room page corresponding to any one sub card can be improved, which is convenient for user operation and improves the user experience.

Optionally, the live room information includes related document information of a corresponding live room, and the related document information includes at least one of the following: current interactive information of the live room, current live content information of a live room streamer, a resource identification related to the current live content information, and a reason why the live room is aggregated into the aggregation live room card.

Illustratively, if the live room is a shopping live room, then the current live content information of the live room streamer can include: at least one of a live room type, a commodity name, an inventory of commodities, and a trading volume. Other information can also be included, which is not limited herein.

Illustratively, if the live room is a concert live room, the current live content information of the live room streamer can include: at least one of a live room type, a current song, a playlist, and an upcoming song. Other information can also be included, which is not limited herein.

Illustratively, the resource identification can include: at least one of a coupon, a price, and lucky money, Other information can also be included, which is not limited herein.

Illustratively, the reason why the live room is aggregated into the aggregation live room card can be any one of the following: a high recommendation index, and followed. Other reason can also be included, which is not limited herein.

The related document information displayed when different live rooms are in an alternate displaying state can be of the same type or of different types, that is, related document information to be presented can be customized in a personalized way for each live room. For example, the related document information displayed when some live rooms are in an alternative displaying state is number of current viewers information, and current interaction information of the live rooms, and the related document information displayed when some live rooms are in an alternate displaying state is current live content information of the live room streamer, and a resource identification related to the current live content information.

In the embodiment of the present disclosure, the related document information of the live room currently in an alternate displaying state is displayed in the first region, which can better improve the exposure of the live rooms, and thus facilitate users to determine whether the live room is a live room meeting the requirement, and can improve the user experience.

It is to be understood that it is possible to update a live room in the first region and update a live room in the second region at the same time or at different times; it is also possible that the first region has an alternate displaying capability and the second region does not have an alternate displaying capability; and it is also possible that the first region does not have an alternate displaying capability and the second region has an alternate displaying capability, which can be specifically determined according to an actual situation and is not limited here.

Optionally, the live room display method provided by the embodiment of the present disclosure can further include the following step 104.

104, updating at least one live room currently displayed in the second region, when updating in the first region a live room currently in an alternate displaying state.

It is to be understood that while an alternate displaying update is performed on the live room displayed in the first region, the alternate displaying update is also performed on the live room displayed in the second region. That is, the alternate displaying update is synchronously performed on the live room displayed in the first region and the live room displayed in the second region. In this way, the alternate displaying update is performed in the first region and in the second region at the same time, which can improve influences, from an update of the live room of the second region, on users viewing the live room information of the first region, due to an asynchronous update, thus giving a better experience in viewing to users.

Illustratively, in the case where the live room currently in an alternate displaying state in the first region is updated from a first live room to a second live room, live preview covers of M live rooms which are aggregated in the aggregation live room card displayed in the second region are updated to live preview covers of K live rooms aggregated in the aggregation live room card, where K is an integer less than or equal to N.

It is to be understood that when a live room in an alternate displaying state is changed, a live preview cover displayed in the second region is automatically updated. In this way, by automatically updating the live preview cover displayed in the second region, more live rooms or detail information of more live rooms can be presented for users, which is beneficial for users to make a selection and can improve the operation efficiency.

Optionally, the method further includes: updating, in response to a second trigger operation on the second region, live preview covers of M live rooms which are aggregated in the aggregation live room card displayed in the second region to live preview covers of K live rooms aggregated in the aggregation live room card.

The second trigger operation can include a swipe operation on the second region, a click operation on the second region (for example, clicking to switch a control or switch an identification (e.g. changing a batch of them, or the like), a zoom operation on the second region, and other feasible operations, which are not limited herein.

The description of the above swipe operation and click operation can refer to the related description of the swipe operation and click operation in the above description of the first trigger operation, and is not limited here.

The zoom operation can be a two-finger swipe zoom operation. Through the two-finger swipe zoom-out operation, live preview covers of more live rooms are controlled to be displayed, and through the two-finger swipe zoom-in operation, preview covers of less live rooms are controlled to be displayed.

It is to be understood that, it is possible to trigger update of a live preview cover displayed in the second region through the second trigger operation on the second region. In this way, users can control updating the live preview cover displayed in the second region according to user's own requirements, more live rooms or detail information of more live rooms can be presented for users, which is convenient for users to make a selection and can improve the operation efficiency.

K can be less than or equal to M, or can be larger than M, which can be specifically determined according to an actual situation and is not limited herein.

It is to be understood that at least one of the K live rooms is different from any of the M live rooms. It is to be understood that any of the K live rooms is different from any of the M live rooms, or that the K live rooms can be live rooms of the M live rooms, or that the M live rooms can be live rooms of the K live rooms, which can be specifically determined according to an actual situation and is not limited herein.

Optionally, any of the K live rooms belongs to one of the M live rooms, but an arrangement sequence of live rooms of the K live rooms is different from the arrangement sequence of the M live rooms, that is, the second trigger operation can include an operation of triggering adjustment of an arrangement sequence of live preview covers of the live rooms.

In the embodiment of the present disclosure, according to requirements, users can adjust an arrangement sequence of the live preview covers displayed in the second region through the second trigger operation, and thus live video preview streams of each live room are alternately displayed in the first region according to the arrangement sequence of live rooms adjusted by users, so that users can first view live video preview streams of the live room of more interest, and the user experience can be improved.

Optionally, a first fully displayed live room in the second region is the live room currently displayed in the first region; or, the live room currently displayed in the first region is not included in the second region.

It is to be understood that, a first fully displayed live room in the second region is the live room currently displayed in the first region. In this way, it is convenient to correspond live room information of the live room currently displayed in the first region to live room information currently displayed at a first position of the second region, and users can clearly know more live room information of the live room currently displayed in the first region, which is convenient for users to subsequently select a live room of interest in the second region to enter a corresponding live room page, which can improve the user experience.

It is to be understood that a live room currently displayed in the first region is not included in the second region. Since live room information of the live room is displayed in the first region, live room information of the live room currently displayed in the first region is not displayed in the second region, and more live room information of other live rooms can be displayed. In this way, live room information of more live rooms can be presented in the aggregation live room card at the same time, which is convenient for users to determine a live room of interest therefrom.

Optionally, the K live rooms include live rooms of the M live rooms other than the live room located at the first position.

It is to be understood that, the K live rooms include live rooms of the M live rooms other than the live room located at the first position, which indicates that each time the live room in an alternate displaying state is updated, the live room displayed in the second region is automatically updated. Moreover, the live room displayed at one position in the second region is updated at a time. Displaying of the live preview cover of the live room at the first position before the update is cancelled, the live preview cover of the live room in other position before the update is moved forward by one position, and a live preview cover of the live room that was not displayed before the update is displayed at a last position after the update.

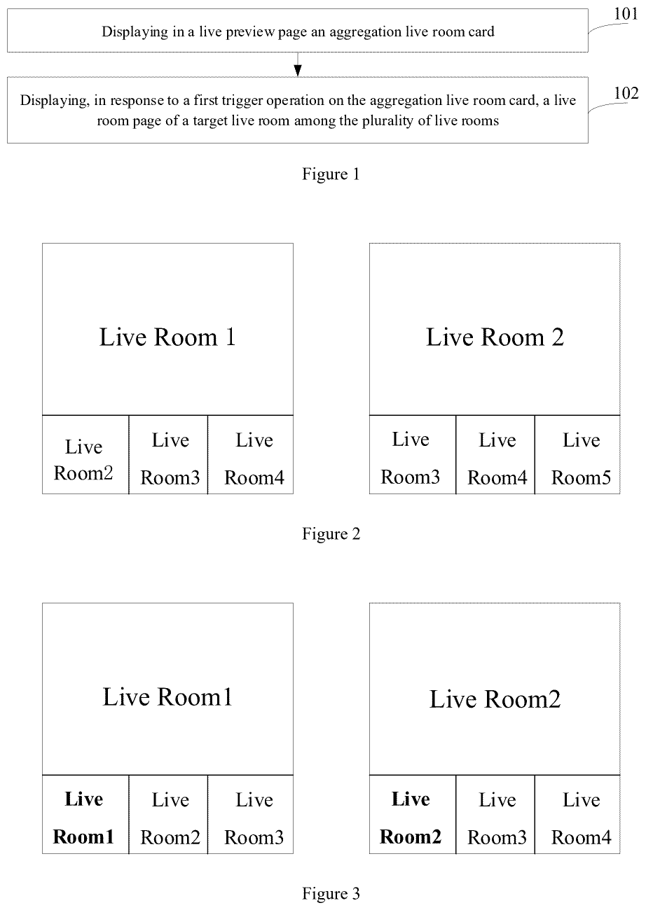

Illustratively, as shown in FIG. 2, before the update, a live room in an alternate displaying state in the first region of the aggregation live room card is Live Room 1, and a live preview cover of Live Room 2, a live preview cover of Live Room 3 and a live preview cover of Live Room 4 are displayed in sequence in the second region of the aggregation live room card; after the update, the live room in the alternate displaying state in the first region of the aggregation live room card is Live Room 2, and a live preview cover of Live Room 3, a live preview cover of Live Room 4 and a live preview cover of Live Room 5 are displayed in sequence in the second region of the aggregation live room card.

Illustratively, as shown in FIG. 3, before the update, a live room in an alternate displaying state in the first region of the aggregation live room card is Live Room 1, and a live preview cover of Live Room 1 (bold indicates that the corresponding live room is currently in an alternate displaying state), a live preview cover of Live Room 2, and a live preview cover of Live Room 3 are displayed in sequence in the second region of the aggregation live room card; after the update, the live room in the alternate displaying state in the first region of the aggregation live room card is Live Room 2, and a live preview cover of Live Room 2, a live preview cover of Live Room 3 and a live preview cover of Live Room 4 are displayed in sequence in the second region of the aggregation live room card.

In the embodiment of the present disclosure, the live preview cover of the live room displayed in the second region is automatically updated while the live room in the alternate displaying state in the first region is updated, so that the exposure of the plurality of live rooms is improved, and it is convenient for users to quickly determine the live room of interest.

Optionally, the live preview covers of the plurality of live rooms can be displayed circularly in the second region according to a preset period. In this way, the exposure of the plurality of live rooms is improved, and it is convenient for users to quickly determine the live room of interest.

Optionally, in the case of displaying the aggregation live room card, the live room display method provided by the embodiment of the present disclosure can further include the following step 105.

105, cancelling, in response to a trigger operation for the second region, displaying of the second region, and adaptively adjusting a display size of the first region.

Optionally, a third trigger operation can be a click operation on a hidden control in the second region, a click operation or a swipe operation on a specific region in the second region, or other feasible operation, which can be specifically determined according to an actual situation and is not limited here.

The description of the above swipe operation and click operation can refer to the related description of the swipe operation and click operation in the above description of the first trigger operation, and is not limited here.

Optionally, in response to the third trigger operation, second region hiding prompt information can also be displayed, wherein the prompt information is used for prompting the second region to be hidden, and a specific content of the prompt information can be “Hidden second region”, “Hidden live preview cover of other live room”, or the like, which can be specifically determined according to an actual situation and is not limited here. By displaying the prompt information, users can be better prompted that the second region is hidden, and users can trigger re-displaying of the second region through other trigger operation, if necessary, so a display size of the first region can be adaptively reduced (or the normal display size of the first region can be restored).

Since displaying of the second region is cancelled, the display size of the first region can be adaptively increased, so that the live video preview stream of the live room currently in the alternate displaying state can be better displayed, which is convenient for users to view more detail information of the live room currently in the alternate displaying state and can improve the user experience.

Optionally, a label of the current live preview page can be “Recommendation”, “Follow” or other label, which is not limited here.

Optionally, the label of the current live preview page is “Recommendation”, and the current live preview page can also include a followed region (that is, information of the followed live rooms is displayed under the “Recommended” label, and types of the live room information presented at the same time can be improved, for example, including both types of the live rooms recommended by the system and types of the live rooms followed by users). The followed region presents a live room identification of at least one live room on a live state among all the live rooms followed by the user; a banner region can also be included in the current live preview page.

The live room identification can be a profile picture of the live room streamer, the name of the live room, or the like, which can be specifically determined according to an actual situation and is not limited here.

Optionally, the live room identifications of the at least one live room can be separately displayed, aggregatively displayed, or partially separately displayed and partially aggregatively displayed. The aggregatively displayed live room identifications can be referred to as an aggregation card, and each aggregation card is aggregated with a plurality of live room identifications. The number of live room identifications aggregated in a different aggregation card can be different or the same, which can be specifically determined according to an actual situation and is not limited here.

Optionally, the live room type corresponding to the live room identifications aggregated in a different aggregation card can be the same or different. The plurality of live room identifications aggregated in the aggregation card can be arranged in a preset mode according to a preset arrangement rule.

The preset arrangement rule can refer to the above related description, and the preset mode can be, for example, a square grid arrangement mode from left to right and from top to bottom, a one-line arrangement mode from left to right, or a one-line arrangement mode from top to bottom, or the like, which is not limited here.

Optionally, when a live room identification in the followed region cannot be fully displayed either separately or aggregatively, it is possible to trigger the update of the currently presented live room identifications through an input to a specific region or control, specifically, it is possible to replace the currently presented live room identification with other live room identification, or enter the follow page which is used for displaying the live room identifications of all followed live rooms.

Illustratively, an aggregation card is displayed at a last position from left to right of the followed region, and live room identifications are separately displayed at the other positions. The live room identifications aggregated in the aggregation card can be combined in different forms according to the number of follow. The live room identifications can be displayed in a preset mode from top to bottom and from left to right in the aggregation card. Number prompt information can also be displayed in the followed region, which is used for prompting users the total number of the followed live rooms. The number prompt information can be “how many live rooms are followed”, “more than how many live rooms are followed”, or the like, which can be specifically determined according to an actual situation.

Optionally, any one of the live room identifications currently displayed in the followed region is clicked so as to directly enter a corresponding live room page. After entering the live room page, it is possible to trigger the arrangement sequence of live rooms determined according to a preset arrangement rule through a preset trigger operation (such as an upward or downward swipe operation) on the live room page, and update displaying of live room pages of other followed live rooms.

Optionally, the “Follow” label can be removed from a top label region of the live preview page, and the live rooms in the follow dimension can be merged under the “Recommendation” label. That is, the followed region is added under the “Recommendation” label, and the followed region can be displayed when there is a followed live streamer on a live and hidden when there is no followed live streamer on a live.

In this way, when the label for displaying the live room preview page is “Recommendation”, live room information in the follow dimension can be displayed under the “Recommendation” label, so that the recommendation dimensions can be richer, the association of recommendation can be closer, and the distribution can be stronger; the exposure of the live room in the follow dimension which is in a closer relationship with users can be improved.

Optionally, the live preview page includes a head region and a live stream region, and the head region is above the live stream region. The head region includes a label region, as well as at least one of an followed region and a banner region. A background board is set in the head region (the live stream region is below the background board), which can be customized according to a platform activity or festival. A size of the background board can be adaptively adjusted according to the size required by the content displayed in the head region. The live stream region is used for displaying at least one live preview card, and each live preview card can be an aggregation live room card or a live room preview card.

Swiping upwards on the live stream region enables a capability of quickly pinning to top: when an upward swipe operation is implemented on the live preview page, the followed region and the banner region are quickly folded and hidden, and the live stream region is presented on the top; When swiping downwards in the live stream region, the followed region and the banner region are still not expanded until the swipe operation reaches top of the live stream region and swipes upwards once again.

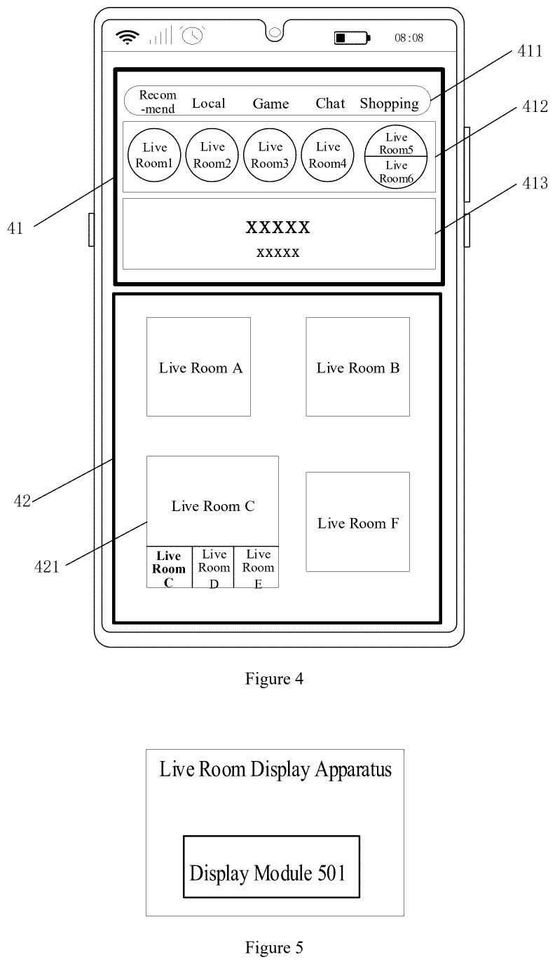

Illustratively, as shown in FIG. 4, the live preview page has a head region indicated by a mark “41” and a live stream region indicated by a mark “42”. The head region includes a label region indicated by a mark “411”, a followed region indicated by a mark “412”, and a banner region indicated by a mark “413”. An aggregation live room card indicated by a mark “421” is included at a third position of the live stream region.

FIG. 5 is a structural block diagram of a live room display device according to an embodiment of the present disclosure. As shown in FIG. 5, a display module 501 is included, which is used for displaying in a live preview page an aggregation live room card which is a live room card corresponding to a plurality of live rooms; displaying, in response to a first trigger operation on the aggregation live room card, a live room page of a target live room among the plurality of live rooms.

Optionally, the aggregation live room card includes a first region. The display module 501 is specifically used for alternately displaying in the first region live room information of each of the plurality of live rooms, or alternately/fixedly displaying in the first region live room information of a live room meeting a first condition among the plurality of live rooms.

Optionally, the first trigger operation is used for triggering entering a target live room in the first region. The display module 501 is specifically used for displaying a live page of the target live room when the target live room is currently in a live state; displaying a forecast page or a recording page of the target live room when the target live room is currently not in a live state.

Optionally, the aggregation live room card further includes a second region, and the first region is larger than the second region. The display module 501 is specifically used for alternately displaying in the second region live room information of at least two of the plurality of live rooms, or alternately/fixedly displaying in the second region live room information of a live room meeting a second condition among the plurality of live rooms.

Optionally, the target live room is a live room in a live state that is currently displayed in the second region. The display module 501 is specifically used for displaying a live page of a live room currently displayed in the second region.

Optionally, the apparatus further includes an update module, which is used for updating at least one live room currently displayed in the second region, when updating in the first region a live room currently in an alternate displaying state.

Optionally, a first fully displayed live room in the second region is the live room currently displayed in the first region. Or, the live room currently displayed in the first region is not included in the second region.

Optionally, the display module 501 is further used for cancelling, in response to a trigger operation for the second region, displaying of the second region, and adaptively adjusting a display size of the first region.

Optionally, the aggregation live room card includes a plurality of sub cards, each of which displays a preview cover or a live preview stream of the live room. The display module is specifically used for entering, in response to a trigger operation for any one of the plurality of sub cards, a live room page corresponding to the any one sub card.

Optionally, the display module 501 is further used for maintaining, in response to a swipe trigger operation for a live preview page, displaying of the aggregation live room card in a preset region of the live preview page.

Optionally, each of the plurality of live rooms meets at least one of the following: a live room with a recommendation index larger than a preset threshold; a followed live room; a preset one of the plurality of live rooms.

In the embodiment of the present disclosure, the various modules can implement the live room display method provided in the above method embodiment, and can reach the same technical effect. In order to avoid repetition, the details are not repeated here.

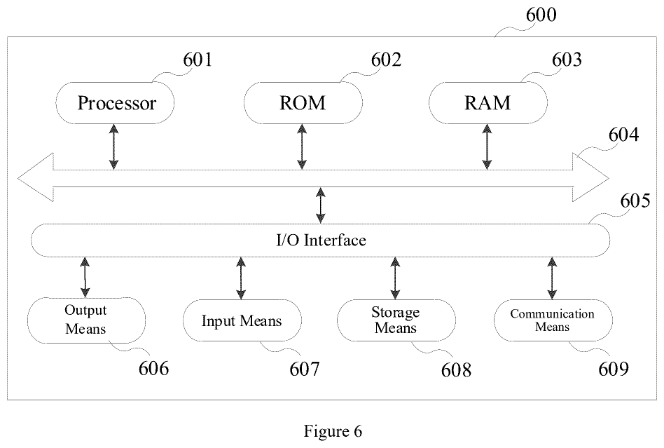

FIG. 6 is a structural schematic diagram of an electronic device provided by an embodiment of the present disclosure, which is used to exemplarily explain the electronic device that implements any live room display method in the embodiment of the present disclosure, and should not be construed as a specific limitation to the embodiment of the present disclosure.

As shown in FIG. 6, an electronic device 600 can include a processor (e.g., a central processor, a graphics processor, etc.) 601 that can execute various appropriate actions and processes in accordance with a program stored in a Read Only Memory (ROM) 602 or a program loaded from a storage means 608 into a Random Access Memory (RAM) 603. In the RAM 603, various programs and data necessary for the operation of the electronic apparatus 600 are also stored. The processor 601, ROM 602, and RAM 603 are connected to each other via a bus 604. An input/output (I/O) interface 605 is also connected to the bus 604.

Generally, the following means can be connected to the I/O interface 605: an input means 606 including, for example, a touch screen, a touch pad, a keyboard, a mouse, a camera, a microphone, an accelerometer, a gyroscope, and the like; an output means 607 including, for example, a Liquid Crystal Display (LCD), a speaker, a vibrator, and the like; a storage means 608 including, for example, a magnetic tape, a hard disk, and the like; and a communication means 609. The communication means 609 can allow the electronic device 600 to perform wireless or wired communication with other devices so as to exchange data. While the electronic device 600 having various means is illustrated, it should be understood that not all illustrated means are required to be implemented or provided. More or fewer means can be alternatively implemented or provided.

In particular, the process described above with reference to the flow diagrams can be implemented as a computer software program, according to the embodiments of the present disclosure. For example, an embodiment of the present disclosure includes a computer program product comprising a computer program carried on a non-transitory computer readable medium, the computer program containing program code for executing the method illustrated by the flow diagram. In such an embodiment, the computer program can be downloaded and installed from a network through the communication means 609, or installed from the storage means 608, or installed from the ROM 602. When the computer program is executed by the processor 601, the functions defined in any live room display method provided by the embodiments of the present disclosure are executed.

It is to be noted that the above-mentioned computer readable medium of the present disclosure can be a computer readable signal medium or a computer readable storage medium or any combination of both the above. The computer readable storage medium can be, for example, but not limited to, an electronic, magnetic, optical, electromagnetic, infrared, or semiconductor system, apparatus, or device, or any combination of the above. More specific examples of the computer readable storage medium can include, but are not limited to: an electrical connection having one or more wires, a portable computer diskette, a hard disk, a Random Access Memory (RAM), a Read-Only Memory (ROM), an Erasable Programmable Read-Only Memory (EPROM or flash memory), an optical fiber, a portable Compact Disc Read-Only Memory (CD-ROM), an optical storage device, a magnetic storage device, or any suitable combination of the above. In the present disclosure, the computer readable storage medium can be any tangible medium that can contain, or store a program for use by or in connection with an instruction execution system, apparatus, or device. In contrast, in the present disclosure, the computer readable signal medium can include a propagated data signal with computer readable program code carried therein, for example, in baseband or as part of a carrier wave. Such a propagated data signal can take any of a variety of forms, including, but not limited to, an electro-magnetic signal, an optical signal, or any suitable combination of the above. The computer readable signal medium can also be any computer readable medium other than the computer readable storage medium and can communicate, propagate, or transport a program for use by or in connection with an instruction execution system, apparatus, or device. Program code embodied on a computer readable medium can be transported using any suitable medium, including but not limited to: electrical wires, optical cables, RF (radio frequency), etc., or any suitable combination of the above.

In some embodiments, clients can communicate with servers using any currently known or future developed network Protocol, such as the HyperText Transfer Protocol (HTTP), and can be interconnected with any form or medium of digital data communication (e.g., a communication network). Examples of the communication network include a Local Area Network (“LAN”), a Wide Area Network (“WAN”), the Internet (e.g., the Internet), and a peer-to-peer network (e.g., an ad hoc peer-to-peer network), as well as any currently known or future developed network.

The above computer readable medium can be contained in the above electronic device, or can be separate and not incorporated into the electronic device.

The above computer readable medium carries one or more programs which, when executed by the electronic device, cause the electronic device to: display in a live preview page an aggregation live room card which is a live room card corresponding to a plurality of live rooms; display, in response to a first trigger operation on the aggregation live room card, a live room page of a target live room among the plurality of live rooms.

In an embodiment of the present disclosure, computer program code for executing operations of the present disclosure can be written in one or more programming languages or a combination thereof. The above programming languages include but are not limited to an object oriented programming language such as Java, Smalltalk, C++, as well as a conventional procedural programming language such as the “C” programming language or similar programming languages. The program code can be executed entirely on a computer, partly on the computer, as a stand-alone software package, partly on the computer and partly on a remote computer, or entirely on the remote computer or a server. In the circumstance where a remote computer is involved, the remote computer can be connected to the computer via any type of network, including a Local Area Network (LAN) or a Wide Area Network (WAN), or can be connected to an external computer (for example, via the Internet using an Internet service provider).

The flow diagrams and block diagrams in the figures illustrate the architecture, functions, and operations of possible implementations of the system, method and computer program product according to various embodiments of the present disclosure. In this regard, each block in the flow diagrams or block diagrams can represent a module, segment, or part of code, which contains one or more executable instructions for implementing the specified logical function(s). It should also be noted that, in some alternative implementations, the functions labeled in the blocks can occur out of the order labeled in the figures. For example, two blocks shown in succession can, in fact, be executed substantially concurrently, or they can sometimes be executed in the reverse order, depending upon the function involved. It is also to be noted that, each or a combination of blocks of the block diagrams and/or flow diagrams can be implemented by a special purpose hardware-based system that executes the specified functions or operations, or by a combination of special purpose hardware and computer instructions.

The involved units described in the embodiments of the present disclosure can be implemented by means of software or hardware. The name of a unit does not in some cases constitute a limitation on the unit itself.

The functions described herein above can be executed, at least in part, by one or more hardware logic components. For example, without limitation, exemplary types of hardware logic components that can be used include: Field Programmable Gate Arrays (FPGAs), Application Specific Integrated Circuits (ASICs), Application Specific Standard Products (ASSPs), system on a chip (SOCs), Complex Programmable Logic Devices (CPLDs), and the like.

In the context of the present disclosure, a computer readable medium can be a tangible medium that can contain or store a program for use by or in connection with an instruction execution system, apparatus, or device. The computer readable medium can be a computer readable signal medium or a computer readable storage medium. The computer readable medium can include, but is not limited to, an electronic, magnetic, optical, electromagnetic, infrared, or semiconductor system, apparatus, or device, or any suitable combination of the above. More specific examples of the computer readable storage medium would include an electrical connection based on one or more wires, a portable computer diskette, a hard disk, a Random Access Memory (RAM), a Read-Only Memory (ROM), an Erasable Programmable Read-Only Memory (EPROM or flash memory), an optical fiber, a portable Compact Disc Read-Only Memory (CD-ROM), an optical storage device, a magnetic storage device, or any suitable combination of the above.

The above description is only illustrative of the preferred embodiments of the present disclosure and the technical principles employed. It should be understood by those skilled in the art that the scope of disclosure involved in the present disclosure is not limited to the technical solution formed by a particular combination of technical features described above, but also encompasses other technical solution formed by any combination of technical features described above or equivalents thereof without departing from the spirit of the above disclosure. For example, the above features and the technical features disclosed in the present disclosure (but not limited to) having similar functions are replaced with each other to form the technical solution.

Further, while various operations are depicted in a particular order, this should not be understood as requiring that such operations be executed in the particular order shown or in a sequential order. Under certain circumstances, multitasking and parallel processing are possibly advantageous. Likewise, while several specific implementation details are included in the above discussion, these should not be construed as limitations on the scope of the present disclosure. Certain features that are described in the context of separate embodiments can also be implemented in combination in a single embodiment. Conversely, various features that are described in the context of a single embodiment can also be implemented in multiple embodiments separately or in any suitable subcombination.

Although the present subject matter has been described in a language specific to structural features and/or methodological acts, it should be understood that the subject matter defined in the appended Claims is not necessarily limited to the specific features or acts described above. Rather, the specific features and acts described above are exemplary forms for implementing the Claims.

1. A live room display method, comprising:
displaying in a live preview page an aggregation live room card which corresponds to a plurality of live rooms;
displaying, in response to a first trigger operation on the aggregation live room card, a live room page of a target live room among the plurality of live rooms.

2. The method according to claim 1, wherein the aggregation live room card comprises a first region;
the displaying in the live preview page the aggregation live room card comprises:
alternately displaying, in the first region, live room information of each of the plurality of live rooms, or alternately or fixedly displaying, in the first region, live room information of live rooms meeting a first condition among the plurality of live rooms.

3. The method according to claim 2, wherein the first trigger operation is used for triggering entering a target live room displayed in the first region;
the displaying the live room page of the target live room among the plurality of live rooms comprises:
displaying a live page of the target live room when the target live room is currently in a live state;
displaying a forecast page or a recording page of the target live room when the target live room is currently not in a live state.

4. The method according to claim 2, wherein the aggregation live room card further comprises a second region, and the first region is larger than the second region;
the displaying in the live preview page the aggregation live room card comprises:
alternately displaying, in the second region, the live room information of each of the plurality of live rooms, or alternately or fixedly displaying, in the second region, live room information of live rooms meeting a second condition among the plurality of live rooms.

5. The method according to claim 4, wherein the target live room is a live room in a live state that is currently displayed in the second region;
the displaying the live room page of the target live room among the plurality of live rooms comprises:
displaying a live page of a live room in a live state that is currently displayed in the second region.

6. The method according to claim 4, further comprising:
updating at least one live room currently displayed in the second region, when updating in the first region the live room currently in an alternate displaying state.

7. The method according to claim 4, wherein a first fully displayed live room in the second region is the live room currently displayed in the first region.

8. The method according to claim 4, further comprising:
cancelling, in response to a trigger operation for the second region, displaying of the second region, and adaptively adjusting a display size of the first region.

9. The method according to claim 1, wherein the aggregation live room card comprises a plurality of sub-cards, each of which displays a preview cover or a live preview stream of the live room;
the displaying, in response to a first trigger operation on the aggregation live room card, the live room page of the target live room among the plurality of live rooms comprises:
entering, in response to a trigger operation for any one of the plurality of sub-cards, a live room page corresponding to said sub-card.

10. The method according to claim 1, further comprising:
maintaining, in response to a swipe trigger operation for a live preview page, displaying of the aggregation live room card in a preset region of the live preview page.

11. The method according to claim 1, wherein each of the plurality of live rooms meets at least one of the following:
a live room with a recommendation index larger than a preset threshold;
a followed live room;
a preset one of the plurality of live rooms.

12. (canceled)

13. An electronic device, comprising: a memory configured to store a computer program; and a processor configured to execute a live room display method comprising:
displaying in a live preview page an aggregation live room card which corresponds to a plurality of live rooms;
displaying, in response to a first trigger operation on the aggregation live room card, a live room page of a target live room among the plurality of live rooms.

14. A non-transitory computer readable storage medium storing thereon a computer program which, when executed by a processor, implements a live room display method comprising:
displaying in a live preview page an aggregation live room card which corresponds to a plurality of live rooms;
displaying, in response to a first trigger operation on the aggregation live room card, a live room page of a target live room among the plurality of live rooms.

15. (canceled)

16. The electronic device according to claim 13, wherein the aggregation live room card comprises a first region;
the displaying in the live preview page the aggregation live room card comprises:
alternately displaying, in the first region, live room information of each of the plurality of live rooms, or alternately or fixedly displaying, in the first region, live room information of live rooms meeting a first condition among the plurality of live rooms.

17. The electronic device according to claim 16, wherein the first trigger operation is used for triggering entering a target live room displayed in the first region;
the displaying the live room page of the target live room among the plurality of live rooms comprises:
displaying a live page of the target live room when the target live room is currently in a live state;
displaying a forecast page or a recording page of the target live room when the target live room is currently not in a live state.

18. The electronic device according to claim 16, wherein the aggregation live room card further comprises a second region, and the first region is larger than the second region;
the displaying in the live preview page the aggregation live room card comprises:
alternately displaying, in the second region, the live room information of each of the plurality of live rooms, or alternately or fixedly displaying, in the second region, live room information of live rooms meeting a second condition among the plurality of live rooms.

19. The electronic device according to claim 18, wherein the target live room is a live room in a live state that is currently displayed in the second region;
the displaying the live room page of the target live room among the plurality of live rooms comprises:
displaying a live page of a live room in a live state that is currently displayed in the second region.

20. The non-transitory computer readable storage medium according to claim 14, wherein the aggregation live room card comprises a first region;
the displaying in the live preview page the aggregation live room card comprises:
alternately displaying, in the first region, live room information of each of the plurality of live rooms, or alternately or fixedly displaying, in the first region, live room information of live rooms meeting a first condition among the plurality of live rooms.

21. The non-transitory computer readable storage medium according to claim 20, wherein the first trigger operation is used for triggering entering a target live room displayed in the first region;
the displaying the live room page of the target live room among the plurality of live rooms comprises:
displaying a live page of the target live room when the target live room is currently in a live state;
displaying a forecast page or a recording page of the target live room when the target live room is currently not in a live state.

22. The non-transitory computer readable storage medium according to claim 20, wherein the aggregation live room card further comprises a second region, and the first region is larger than the second region;
the displaying in the live preview page the aggregation live room card comprises:
alternately displaying, in the second region, the live room information of each of the plurality of live rooms, or alternately or fixedly displaying, in the second region, live room information of live rooms meeting a second condition among the plurality of live rooms.
